(19) United States
(12) Patent Application Publication
(10) Pub. No.: US 2004/0170225 A1
(43) Pub. Date: Sep. 2, 2004

(54) Method and system for transferring data

(76) Inventors: Stefan Krause, Munchen (DE); Heinrich Schenk, Munchen (DE)

Correspondence Address: Aaron Wininger, Squire Sanders & Dempsey, 600 Hansen Way, Palo Alto, CA, 94304, US

(21) Appl. No.: 10/477,635

(22) PCT Filed: May 3, 2002
(86) PCT No.: PCT/EP02/04929

(30) Foreign Application Priority Data
May 11, 2001 (DE) 101228910

(51) Int. Cl. H04L 27/00

(52) U.S. Cl. 375/259

(57) ABSTRACT

In a transmission system with Tomlinson preceding, the data are transmitted with N amplitude levels. In order to be able to resume the data transmission quickly and with little outlay after a temporary interruption, test signals (15-18) with data symbols which have W amplitude levels out of the overall N amplitude levels are transmitted in a warm-start phase for synchronisation or adjustment of a receiver (C), W and N being integers and W being <N. Even though only W amplitude levels are transmitted, the test signals are Tomlinson-precoded using N levels on the transmitter side and decoded using N levels on the receiver side, so that the transient process of the Tomlinson filter (2) is not perturbed when switching over to the N-level data mode and it is not necessary to change the Tomlinson preceding and decoding which depend on the number of data levels. The invention can be used, in particular, for the SDSL standard, although it may be used in all systems with Tomlinson preceding.

The invention relates to a method for configuring a data transmission system according to the precharacterising clause of Patent claim 1, as well as to a transmitter and a receiver for data transmission according to the precharacterising clauses of Patent claims 8 and 10, respectively.

Such a method is known from the publication by the company Infineon Technologies AG “SDSL Warm Start: State Sequence”, TD 08 001t08a0, ETSI TM6, Feb. 2000. This publication describes a warm-start method for a data transmission system according to the SDSL standard, in which Trellis coding and Tomlinson precoding are used for encoding the data in a data-transmission phase. Data symbols having N levels are used for the data transmission. In order to establish a data transmission connection between a transmitter and a receiver, a two-level data signal is initially transmitted from the transmitter to the receiver without Tomlinson preceding. This transmitter uses the two-level data signal to determine the appropriate coefficients for a decision feedback equalizer and carries out synchronisation. The coefficients of the decision feedback equalizer which have been determined are transmitted in a return channel to the transmitter, which uses these coefficients for a Tomlinson filter of the Tomlinson preceding. Operation is then switched over to an N-level data signal which is Tomlinson-precoded using N levels in the transmitter, the decision feedback equalizer in the receiver being turned off. If the data transmission needs to be resumed after a temporary interruption, a warm start is carried out in which, in the aforementioned company document, the transmitter sends out a two-level data signal which has been Tomlinson-precoded using two levels, which is then Tomlinson-decoded by the receiver using two levels and with the aid of which the receiver carries out the synchronisation, the coefficients determined during a previously performed cold start being used for the Tomlinson preceding and decoding, respectively. In contrast to the cold start, the decision feedback equalizer remains switched off during a warm start of this kind. With this method, two different types of Tomlinson decoding disadvantageously need to be carried out in the receiver, on the one hand N-level decoding of the data signal in the data-transmission phase and, on the other hand, two-level decoding in the warm-start phase. Perturbation of the transient process of the Tomlinson filter, which can lead to synchronisation problems in the receiver, is furthermore encountered when switching over from the two-level Tomlinson mode to the N-level Tomlinson mode.

It is an object of the present invention to provide a method, as well as a transmitter and a receiver, of the type mentioned in the introduction for correct and unimpaired reception of a data transmission with little outlay.

According to the invention, this object is achieved by a method having the features of claim 1 as well as a transmitter and a receiver having the features of claim 8 and 10, respectively. The dependent claims respectively define preferred and advantageous embodiments of the present invention.

The data are also transmitted in the form of N-level data symbols after having been Tomlinson-precoded using N levels in the system according to the invention. In order to be able to resume the data transmission quickly by a warm start after it has been temporarily interrupted, a data symbol test signal which has W levels, i.e. it exclusively has data symbols corresponding to W levels out of the N symbol levels, is transmitted after having been Tomlinson-precoded using N levels from the transmitter to the receiver, where it is decoded using N levels. The use of W<N levels, in particular two levels, for the transmission of the test signal serves to provide the receiver with correct synchronisation which was lost during the interruption of the data transmission.

With the use of a large number of data symbol levels N for transmitting the data in the data-transmission phase, it is possible to achieve a high data transmission rate relation to the data symbol frequency, the number N preferably being sixteen.

During the Tomlinson preceding, the data symbol signal is added to the output signal of a Tomlinson filter, and this sum signal is processed by means of a modulo operation to form a transmission signal, which is in turn sent to the input of the Tomlinson filter. During this modulo operation, a check is made as to the amplitude range in which the sum signal comprising the data symbol signal and the output signal of the Tomlinson filter lies, and a particular value is added or subtracted depending on this, the amplitude range as well as the values to be subtracted or added depending on the number of levels. By the use of Tomlinson preceding and decoding with the same number of levels as is subsequently used in the data-transmission phase, the embodiment outlay is reduced since the Tomlinson precoding and decoding in the warm-start phase is the same as in the data-transmission phase. In addition, more reliable synchronisation is achieved in this way since the transient process of the Tomlinson filter is not perturbed when switching over to the data mode, i.e. when changing from the warm-start phase to the data-transmission phase. A filter of this kind can be used in all systems with Tomlinson preceding, and especially in systems with quadrature amplitude modulation.

The W levels for the warm-start phase are preferably selected from the overall N data signal levels so that, during this phase, the signal which has been Tomlinson precoded using N levels entails a transmission power as similar as possible to that for the N-level transmission.

The warm-start phase may be started by a request signal, which is sent from the transmitter of a first data transmission station to the receiver of a second data transmission station, in which case the receiver may confirm arrival of the request signal by sending an acknowledging request signal back to the transmitter via a return channel.

In order to resume the data transmission, and in particular in order to carry out synchronisation on the receiver side, a test signal which contains a predetermined data sequence, for example purely scrambled logical ones, may be sent from the transmitter to the receiver in the warm-start phase, and according to the invention it is transmitted after having been Tomlinson-precoded using N levels to the receiver, which adjusts a reception instrument for correct data reception with the aid of the received test signal. This may, for example, involve the synchronisation of an analogue/digital converter or the adjustment of an input filter.

The receiver may acknowledge the arrival of the test signal by sending out a reception confirmation test signal via the return channel. This confirmation signal may likewise be a predetermined data sequence and also be used to adjust a data reception instrument of another data transmission station.

In the warm-start phase, after adjustment of the reception instrument has been carried out, it is also conceivable for the receiver to send an adjustment confirmation test signal to the receiver, which is in this way informed that the adjustment of the reception instrument, or synchronisation on the reception side, has taken place successfully.

For the construction of a data transmission system according to the invention, in which bi-directional data transmission is intended to be possible between two data transmission stations, each data transmission station should be equipped with a transmitter and a receiver; the method according to the invention may be used for carrying out a warm start for the data transmission in one or both directions.

The invention will be explained in more detail below with the aid of a preferred exemplary embodiment with reference to the appended drawing.

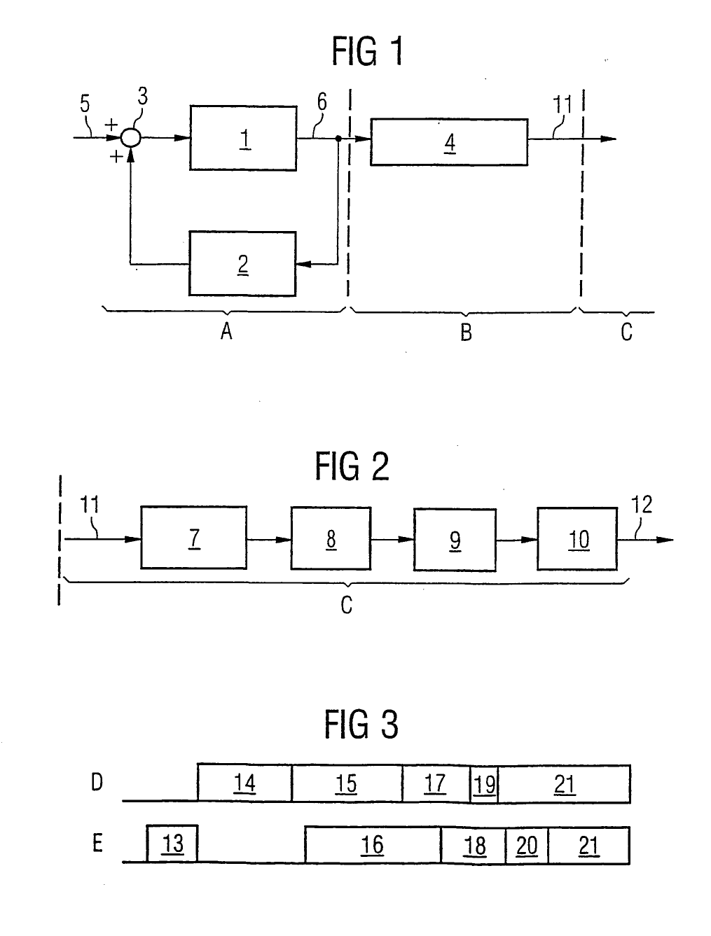

FIG. 1 shows a Tomlinson precoder of a transmitter configured according to the exemplary embodiment of the invention, as well as the transmission path used for the data transmission,

FIG. 2 shows a receiver for use in the embodiment described, and

FIG. 3 shows the chronological order of the test signals used for the warm start in the exemplary embodiment.

FIGS. 1 and 2 represent a data transmission system, in which data are transmitted from a transmitter A via a transmission path B to a receiver C. The Tomlinson precoder (represented in FIG. 1) of the transmitter A consists of a modulo encoder 1, a Tomlinson filter 2 and an adder 3, a transmission signal 6 being provided at the output of the modulo encoder 1 which, on the one hand, is transmitted via a path 4 to the receiver C and, on the other hand, is sent to the input of the Tomlinson filter 2. The output of the Tomlinson filter 2 is connected to the adder 3, which forms the sum of the output signal of the Tomlinson filter 2 and a data symbol signal 5, containing the data to be transmitted, and sends this sum to the input of the modulo encoder 1.

The modulo encoder 1 is configured so that its output signal 6 takes the following values, the data symbol 5 being denoted by a, the transmission signal 6 being denoted by u and the output signal of the Tomlinson filter 2 being denoted by y in what follows for the sake of clarity, and the values being considered at a particular time in the table below:

u=a+y if −N<a+y<=N

u=a+y2N if N<a+y<=3N

u=a+y+2N if −3N<a+y<=−N

u=a+y−4N if 3N<a+y<=5N

u=a+y+4N if −5N<a+y<=3N

etc.

In this way, the modulo encoder 1 ensures that the transmission signal 6 always varies in the range between −N and +N irrespective of the sum signal which is formed by the adder 3.

In the described exemplary embodiment, a sixteen-level data signal is used in the data-transmission phase, so that N=16 in the aforementioned table. This means that sixteen different data symbols overall are used for the data transmission, these being taken from the number set (−15, −13, −11, −9, . . . , −3, −1, +1, +3, . . . , +9, +11, +13, +15).

The transmission signal 6 becomes altered during the transmission of the transmission signal 6 over the path 4, in particular by having noise superimposed on it, so that a reception signal 11 which is different from the transmission signal 6 is received on the side of the receiver C.

FIG. 2 represents a block diagram of the receiver C, only the components required for the data reception in the data-transmission phase and in the warm-start phase being represented. The receiver C also has a decision feedback equalizer (not shown), although this is needed only in a cold-start phase in order to determine the coefficients for the transmitter-side Tomlinson filter 2. The receiver C has an input filter 7, an analogue/digital converter 8, a modulo decoder 9 and a decider 10 interconnected to form a signal chain, the reception signal 11 being sent to the input of the input filter 7 and a data symbol signal 12, which contains the data to be transmitted, being provided at the output of the decider 10.

Correct synchronisation of the analogue-digital converter 8, in particular, is necessary for proper operation of the receiver C in the data-transmission phase. The computation operations applied by the modulo decoder 9 are determined exclusively by the number of data symbol levels, but this is already known so that the modulo decoder 9 can be operated without special adjustments in the data-transmission phase. The purpose of the decider 10 is to assign a particular data symbol to the value provided at the output of the modulo decoder 9, in order to obtain a data symbol signal 12 from the reception signal 11.

If the data transmission has been interrupted only temporarily, fresh determination of the coefficients for the Tomlinson filter 2 can be obviated when resuming the data transmission, so that the data transmission can be resumed with a warm start which can be carried out faster. To this end, the sequences of test signals represented in FIG. 3 are used. The signal sequences represented describe the structure of a data transmission between a first data transmission station, or station, D and a second data transmission station, or station, E. The two data transmission stations D, E have both a transmitter A and a receiver C, the transmitter A of a data transmission station D, E being connected to the receiver C of the other respective data transmission station D, E.

The test signals needed for carrying out a warm start are sent out with two data symbol levels, which are selected from the sixteen data symbol levels that are used for the data transmission in the data-transmission phase, in order to be able to carry out the synchronisation correctly on the receiver side. For example, the two values −9 and +9 may be used for the transmission of the test signals, which lead to a transmission power that is as close as possible to the average transmission power during the sixteen-level transmission.

The warm-start phase is initiated by the second data transmission station E which sends a request signal 13 to the first station D, which in turn sends back a request confirmation signal 14 as confirmation of the reception of the request signal 13 after it has ended. At the end of the confirmation signal 14, the first station D sends a first test signal 15, which contains logical ones. As soon as the second station E receives the first test signal 15, it in turn sends back a second test signal 16, which likewise contains scrambled logical ones. In this case, the time lag between the beginning of the first test signal 15 of the first test station D and the beginning of the second test signal 16 of the second station E may be monitored, and the warm-start process may be terminated and a cold start initiated instead if the time lag exceeds a particular value.

For a particular period of time, therefore, the first test signal 15 is sent from the first station D to the second station E and the second test signal 16 is simultaneously sent from the second station E to the first station D, so that the receivers C of the two stations D, E can carry out the synchronisation.

As soon as the first station D has successfully carried out the synchronisation, it sends out a first adjustment confirmation signal 17. Likewise, the second station E sends out a second adjustment confirmation signal 18 after successful synchronisation. As soon as one of the stations D or E receives the adjustment confirmation signal 17 or 18 from the other respective station E or D, it sends out a synchronisation signal 19 or 20. As soon as the last bit of the synchronisation signal 19 or 20 has been transmitted, the corresponding station D or E begins the transmission of a data signal 21 with payload data. The transmission of the data 21 is carried out using sixteen levels.

The aforementioned sequence of test signals in the warm-start phase makes it possible to ensure that the data signals 21 are not transmitted until it is certain that the receiver C being used to receive the data signal 21 has been adjusted or synchronised correctly. Adjustment of the input filter may also be carried out in the receiver C, in addition to the synchronisation.

1. Method for configuring a data transmission system, in which N-level data symbols (5) to be transmitted are Tomlinson-precoded using N levels in a transmitter (A), transmitted to a receiver (C) and decoded in the receiver (C) according to the N-level Tomlinson precoding used in the transmitter (A), in which method, in a warm-start phase, a data symbol test signal (15-18) with W data symbol levels is Tomlinson-precoded, transmitted to the receiver (C) and decoded there, W and N being integers and W being <N, characterised in that,
in the warm-start phase, a test signal (15-18) exclusively comprising data symbols which have W levels out of the N data symbol levels, is Tomlinson-precoded using N levels in the transmitter (A) and decoded in the receiver (C) according to this N-level Tomlinson preceding.

2. Method according to claim 1, characterised in that W is two.

3. Method according to claim 1 and 2, characterised in that N is sixteen.

4. Method according to claims 1-3, characterised in that the warm-start phase is started by a request signal (13, 14), which is sent from the transmitter (A) of a first data transmission station (D) to the receiver (C) of a second data transmission station (E).

5. Method according to claims 1-4, characterised in that, in the warm-start phase, a test signal (15, 16) is sent from the transmitter (A) of a first data transmission station (D) to the receiver (C) of a second data transmission station (E), and the receiver (C) of the second data transmission station adjusts a reception device for correct data reception with the aid of the received test signal (15, 16).

6. Method according to claim 5, characterised in that the second data transmission station (E) confirms the reception of the test signal by sending out a reception confirmation test signal (16).

7. Method according to claim 5 or 6, characterised in that the second data transmission station (E) sends out an adjustment confirmation test signal after adjustment of the reception instrument has been carried out with the aid of a received test signal.

8. Transmitter for data transmission having a Tomlinson encoder (1, 2, 3), the transmitter (A) being configured in such a way that N-level data symbols to be transmitted are Tomlinson-precoded by it using N levels and sent out in a data-transmission phase, and a data symbol test signal (15-18) with W data symbol levels is Tomlinson precoded and sent out in a warm-start phase, W and N being integers and W being <N, characterised in that the transmitter (A) is configured in such a way that, in the warm-start phase, it Tomlinson-precodes and sends out a test signal (15-18) exclusively comprising data symbols which have W levels out of the N data symbol levels.

9. Transmitter according to claim 8, configured for use in a method as claimed in one of claims 1-7.

10. Receiver for data transmission having a Tomlinson decoder (9), the receiver (C) being configured in such a way that N-level data symbols (11) which were Tomlinson-precoded using N levels and have been received in a data-transmission phase are decoded by it using N levels, and a received Tomlinson-precoded data symbol test signal (15-18), exclusively comprising data symbols which have W levels out of the N data symbol levels, is Tomlinson-decoded by it using N levels in a warm-start phase.

11. Receiver according to claim 10, configured for use in a method as claimed in one of claims 1-7.
